(19) United States
(12) Patent Application Publication
(10) Pub. No.: US 2019/0065327 A1
(43) Pub. Date: Feb. 28, 2019

(54) EFFICIENT VERSIONED OBJECT MANAGEMENT

(71) Applicant: Nicira, Inc., Palo Alto, CA (US)

(72) Inventors: Michael Wei, Palo Alto, CA (US); Dahlia Malkhi, Palo Alto, CA (US); Medhavi Dhawan, Cupertino, CA (US); Maithem Munshed, Palo Alto, CA (US); Anny Martinez Manzanilla, Santa Clara, CA (US); Roger Michoud, Menlo Park, CA (US); Zeeshan Lokhandwala, Santa Clara, CA (US)

(21) Appl. No.: 15/880,861

(22) Filed: Jan. 26, 2018

Related U.S. Application Data
(60) Provisional application No. 62/552,889, filed on Aug. 31, 2017.

(51) Int. Cl. G06F 11/14; G06F 17/30

(52) U.S. Cl. CPC G06F 11/1471; G06F 17/30356; G06F 17/30365; G06F 17/30377; G06F 2201/82; G06F 17/30607; G06F 11/1451; G06F 2201/80; G06F 2201/805; G06F 17/30575

(57) ABSTRACT

Described herein are systems, methods, and software to enhance the management of data objects in a data storage system. In one implementation, a client in a data object environment is configured to identify a request for a data object in a first version from process on the client. Once the request is identified and the data object is provided or made available to the requesting process, the object storage system identifies a modification request for the data object to modify the data object from the first version to a second version. In response to the modification request, the object storage system generates an undo log entry to reflect the changes from the first version to the second version and updates the data object to the second version.

### RELATED APPLICATIONS

This application hereby claims the benefit of and priority to U.S. Provisional Patent Application No. 62/552,889, titled “EFFICIENT VERSIONED OBJECT MANAGEMENT,” filed Aug. 31, 2017, and which is hereby incorporated by reference in its entirety.

### BACKGROUND

In computing environments, distributed and clustered database systems provide an efficient and dynamic platform for organizations to maintain their required data. These databases may use various redundancy and versioning mechanisms to ensure that the data for the organization is provided with high availability to any requesting physical or virtual client of the computing environment.

In some implementations, the database systems may be accessible by multiple clients at any one instance, which may cause conflicts when multiple client computing systems and/or multiple processes on an individual client system are requesting the same data. To overcome this deficiency, some database systems provide a locking mechanism, which prevents multiple clients or processes from accessing the data at the same instance. For example, a first client may request a row in a database, which would prevent any other clients or processes from accessing that same row while the first client is accessing the data. However, this locking mechanism provides inefficiencies as the other clients and processes are required to wait to access requested data. In other implementations, database systems may generate multiple copies for each of the requesting clients and/or processes. Thus, when a first client requests a copy of a data object, a first copy of the data object is provided, and when a second client or process on the same client requests a copy of the data object, a second copy of the data object is provided. However, although each of the clients or processes may access a version of the data object at the same instance, generating multiple copies for each of the requesting processes provides inefficiencies in managing resources. In particular, unnecessary memory resources may be required to handle the additional copies for each of the clients and/or processes, limiting resources that could be provided to other operations.

### SUMMARY

The technology described herein enhances the management of versioned data objects according to an implementation. In one example, a client in an object computing environment is configured to identify a request for a data object in a first version. Once the request is identified, the client identifies a modification request for the data object to modify the data object from the first version to a second version. In response to the modification request, the client generates an undo log entry to reflect the changes from the first version to the second version and updates the data object to the second version.

In some implementations, the client may further be configured to update a redo log, which can provide information about the update to other clients within the computing environment.

### BRIEF DESCRIPTION OF THE DRAWINGS

FIG. 1 illustrates a computing environment for managing versioned data objects according to an implementation.

FIG. 2 illustrates an operation of a client system to manage versioned data objects according to an implementation.

FIG. 3 illustrates a timing diagram of managing a data object request according to an implementation.

FIG. 4 illustrates a data structure to manage a versioned data object according to an implementation.

FIG. 5 illustrates an operational scenario of updating redo and undo logs according to an implementation.

FIG. 6 illustrates an operational scenario of updating locally maintained logs and data objects according to an implementation.

FIG. 7 illustrates a client computing system to manage versioned data objects according to an implementation.

### DETAILED DESCRIPTION

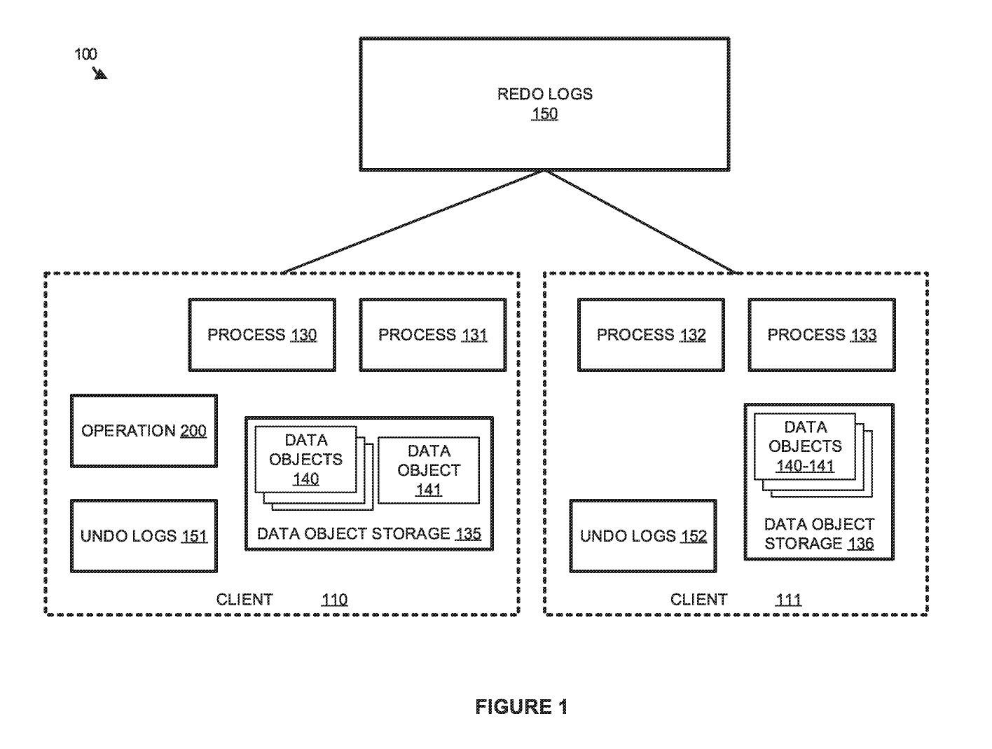

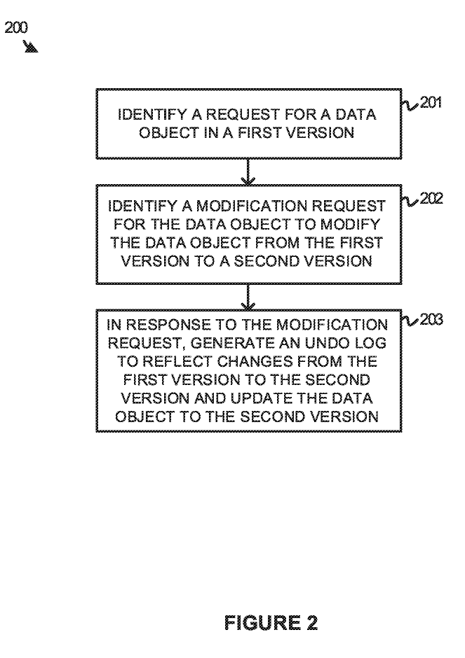

FIG. 1 illustrates a computing environment 100 for managing versioned data objects according to an implementation. Computing environment 100 includes clients 110-111 and redo logs 150, wherein redo logs 150 may be distributed across the same computing systems as clients 110-111 (such as serving computing systems), may be stored on a separate computing system from clients 110-111, or may be stored on some combination thereof. Clients 110-111 include processes 130-133, which are representative of services (such as large data processing applications) that may request and modify data objects provided in computing environment 100. Clients 110-111 further include undo logs 151-152, and data object storage 135-136 with data objects 140-141. Client 110 further includes operation 200, which is further described in FIG. 2 below.

In computing environment 100, clients 110-111 and redo logs 150 may be deployed by an organization to store large data sets, such as those deployed within relational databases or some other object management data structure(s). In the present example, clients 110-111 maintain data object storage 135-136, wherein each data object storage includes a copy of data objects 140-141, and wherein the objects may include tables, columns in a table, rows of a table, individual entries in the tables, or some other similar object. As the objects are maintained, which may include data representative of profile information for users, configuration information for servers in a data center (e.g. software defined switches, firewalls, and router configurations), or some other similar information, processes 130-133 on clients 110-111 may request a data object from the corresponding data object storage. For example, process 130 may request a data object, such as a row reflecting user profile information, from data object storage 135. In response to the request, the requested object may be identified and provided to the requesting process.

In some implementations, such as that depicted in FIG. 1, the objects that are stored in data object storage 135-136 may be associated with multiple versions. These versions may be maintained using redo logs 150 and undo logs 151-152, wherein redo logs 150 and undo logs 151-152 maintain information indicating differences between each version of data objects 140-141. In particular, while redo log 150 is shared between clients 110-111 and may be used to update data objects across systems, undo logs 151-152 are unique to their corresponding client and maintain information to rollback or revert to an earlier version of the data object.

FIG. 2 illustrates an operation 200 of a client system to manage versioned data objects according to an implementation. The processes of operation 200 are described parenthetically in the paragraphs that follow with reference to systems and elements of computing environment 100 of FIG. 1. In particular, reference will be made to a request for data object 141 by a process on client 110, however, it should be understood that similar operations may be provided with respect to other data objects stored in data object storage 135. Further, while demonstrated using client 110, it should be understood that similar operations may be employed by client 111.

As depicted in FIG. 2, operation 200 includes identifying (201) a request for a data object in a first version. Referring to the configuration of computing environment 100, computing environment 100 provides a platform that permits scalability in storing large data sets, such as relational databases, which include a plurality of data objects. These data objects may include rows or columns in a table, a single entry in a database, or some other similar data object. Once an object is stored, processes 130-133 executing on clients 110-111 may be required to access the data to perform various operations on the data including analyzing the state of the data at a particular instance, modifying a data object in data object storage 135-136, or some other similar operation. For example, process 130 on client 110 may request data object 141 to manipulate the data stored in data object 141, and operation 200 may provide access to the data object in response to the request.

In some implementations, the request by the process may specify a version of the object that is preferred by the process. For example, data object 141 may be on its tenth version, but process 130 may request version eight. To accommodate the request, operation 200 may be used to apply undo logs 151 to provide data object 141 with the appropriate version, wherein the undo logs include information of how to revert an object to the previous version.

Once the data object is provided to the requesting process on client 110, the process may request, and operation 200 may identify (202) a modification request for the data object to modify the data object from the first version to a second version. Returning to the example of process 130 requesting data object 141, if data object 141 represented a user profile, process 130 may make modifications to an entry for the profile, such as an address for the user, a phone number for the user, or some other similar modification to the user profile. Once the modification request is identified for the process, operation 200 further generates (203) an undo log entry to reflect the changes from the first version to the second version, and may update the data object to the second version in data object storage 135.

In some implementations, the generation of the undo log entry by operation 200 may be used to permit processes on client 110 to access multiple versions of the same data object. Referring back to the modification of the user profile, when process 130 makes a modification to the data object representing the user profile, an undo log entry may be generated such that the previous version of the profile can still be accessed by other clients of the computing environment. In particular, the undo log entry (which may comprise a delta file in some implementations) may include information about how to revert the data object to the previous version. Thus, if process 130 were to make a modification to an address of the user profile, an undo log may be generated that provides information of how to revert the address to the previous version.

In addition to updating the undo logs that are local to the client, it should be understood that the client may also generate redo log entries that are provided to redo logs 150. This redo log entry may be supplied to other clients within the computing environment, permitting the other clients to update locally stored versions of the data objects. In particular, the redo logs may permit each of the clients to locally update a version of the data object and generate an undo log to revert the data object to a previous version.

Although the example of FIG. 2 includes a single process accessing a data object on a client, it should be understood that multiple processes (on the same client or across clients) may access a single object at any one instance. For example, when process 130 is accessing data object 141, process 131 may also supply a request for the same data object and version. Here, rather than preventing process 131 from accessing the data object or making a duplicate copy of the data object, operation 200 may monitor for any modifications that either process 130 or process 131 requests to make to the data object and reflects the changes in redo logs 150 and undo logs 151. In particular, if process 131 were to make a change to data object 141, then operation 200 may identify the request, update the object in data object storage 135, and generate at least one log entry that identifies differences between the first version supplied to process 131 and the updated version modified by process 131. Once the object has been modified, if process 130 attempts to make a modification to the same object, an error may be identified by operation 200 to prevent the implementation of the modification to the data object. In particular, because a new version of the object has been generated by process 131, the object that was provided to process 130 may be obsolete. As a result, the modification may be prevented from being executed, the modification may be permitted, the new version of the object may be provided to process 130 to execute or abort the modification, or some other conflict resolution may be provided via operation 200.

Referring to the example of modifying an address in a user profile, when process 131 makes a modification to the first version of the object, a second version of the object is updated within data object storage 135 and at least one log file is generated that indicates the changes made between the first version and the second version of the object, such that the second version may be reverted to the first version. Once the second version is updated, process 130 may generate a request to modify the first version of the object, wherein the modification may be identified as improper by operation 200 executing on client 110. In response to identifying the improper modification, operation 200 may prevent the update to the data object, permit the update of the data object, supply the newest version of the object to process 130, or some other similar conflict resolution operation. In the example of providing the newest object to process 130 as a conflict resolution, process 130 may update the object with the previously requested modifications, make an alternative modification, or take no action with respect to the data object. If a modification is requested from process 130, then a third version of the object may be updated in data object storage 135, and a new log entry may be generated that reflects the differences between the third version of the object and the second version of the object.

In some implementations, when modifications are being made by processes 130-133 temporary or optimistic logs may be generated prior to committing changes to logs 150-152. In particular, prior to executing a modification or finalizing a change, each of the processes may maintain their own undo and redo logs. Once a modification is committed, which is the operation described in the processes of FIG. 2, the optimistic logs may be merged with redo log 150 and the appropriate undo log of undo logs 150-151. For example, process 130 may request the newest version of data object 141, and subsequently, may make modifications to the data object. Prior to the modifications being committed to logs 150-152, process 130 may maintain optimistic logs, wherein data object 141 may be modified in memory (data object storage 135), but the logs are only maintained locally for the process. Once the modifications are committed, both undo logs 151 and redo logs 150 may be updated to reflect the change using the optimistic logs (i.e. the redo logs updated to indicate how to change the previous version to the newest version and the undo logs updated to indicate how to change the newest version to the previous version).

By maintaining the optimistic logs, the optimistic logs may also assist in managing conflicts between processes executing on the same client. Referring again to process 130 requesting and making modifications to data object 141. While process 130 is modifying the data object (prior to committing the modification), process 131 may request the same version of the object that was originally requested by process 130. To accommodate the request, data object 141 stored in data object storage 135 may already include the modifications by process 130. As a result, the optimistic logs maintained by process 130 may be consulted to generate the data object at the proper version for process 131. Once provided, process 131 may make modifications to the objects (sometimes not reflected in data object storage 135) and maintain its own optimistic logs on the version of the data object provided. Because both the processes are making modifications to the data object (wherein one may make modifications to the object itself in data object storage 135 while the other merely makes log entries to monitor its modifications), when the processes execute or finalize their modifications, a conflict resolution may take place in updating the data object. This resolution may include preventing any modification to the object (i.e. reverting it back to its previous version), permitting both modifications, or some other resolution.

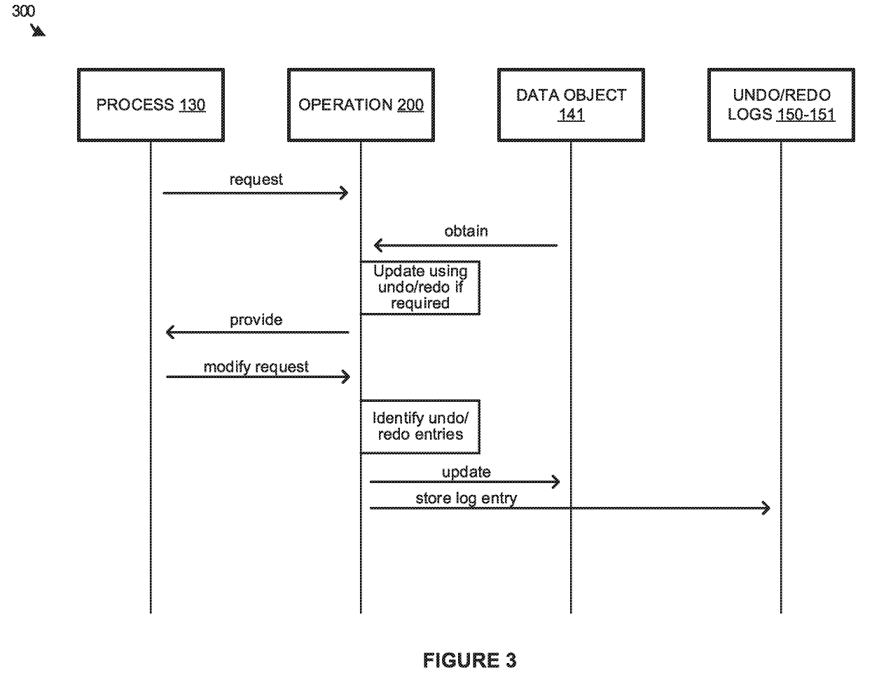

FIG. 3 illustrates a timing diagram 300 of managing a data object request according to an implementation. Timing diagram 300 includes process 130, operation 200, data object 141, and undo/redo logs 150-151.

As depicted, operation 200 identifies a request for a data object from process 130. In response to the request, operation 200 obtains the data object 141 associated with the request, and updates the data object using any undo and redo logs as required. For example, if a previous version of the data object is requested, then the undo logs may be used to revert the data object to the appropriate version. Additionally, in some implementations, operation 200 may monitor the redo logs to determine if any changes to the objects were made by other clients in the computing environment, and apply redo log entries if required to the data object. Once the object is made into the proper version, operation 200 may provide the object to process 130.

After being provided with the data object, process 130 may, if the request was for the most recent version of the data object, generate a request to modify the data object that is identified by operation 200. In some implementations, this request may be made for any modification to the object, however, it should be understood that process 130 may be required to provide a commit or finalize operation to provide the request. Once the request is received, operation 200 may identify undo and redo entries for logs 150-151, update the object in data object storage and store the log entries in logs 150-151.

In some implementations, when a modification request is received, operation 200 may be required to determine if a conflict has occurred, such as another process in the computing environment committing a modification to the data object prior to the commitment by process 130. Once a conflict is identified, process 200 may enter the modification, block the modification, or provide some other similar operation with respect to the modification conflict.

In some examples, by generating a redo log entry for redo logs 150, the redo log entries may be used to update other clients in the computing environment. In particular, the log entries may be used to update the object storage on each of the clients to reflect the changes on the originating client. Further, the undo log entry for undo logs 151 may be used locally to revert an object back to a previous revision. For example, if process 130 were to update a data object to a newer version, then an undo log entry may be generated that includes information of how to revert the object from the newer version to the previously identified version.

Although demonstrated in the example of FIG. 3 as updating the logs 150-151 in response to a modification from process 130, it should be understood that in some implementations process 130 may manipulate the data object and maintain its own temporary or optimistic logs prior to executing or finalizing the modifications. Once executed, the optimistic logs may be merged with logs 150-151 to support the update. In contrast, if the modifications are never executed by the process, the data object may be reverted to its previous state and no changes will appear in logs 150-151. These temporary logs may also be used in managing conflicts between processes as described previously in FIG. 2.

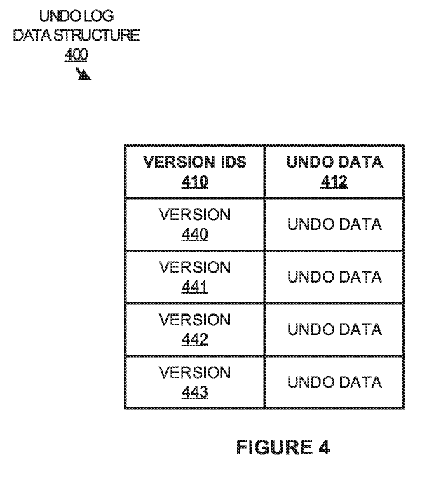

FIG. 4 illustrates an undo log data structure 400 to manage a versioned data object according to an implementation. Data structure 400 includes columns for version identifiers (IDs) 410 and undo data 412, and is an example of a data structure that is maintained by a client in computing environment 100. Although demonstrated in the example of FIG. 4 as including four versions, it should be understood that any number of versions may be made available for a particular data object.

As described herein, a computing environment may include one or more computing systems that are used to provide a platform for object storage (such as relational databases). These computing environments may include a plurality of client computing systems with processes executing thereon that access and process data objects that are stored on each of the client computing systems. To provide the ability for processes executing in the computing environment to access different versions of a data object, logs may be generated, wherein the logs maintain information about the differences between each of the versions.

Referring to example data structure 400, version 440 may represent differencing data to revert or undo a second version of an object to a first version of an object. Similarly, version 441 may include undo data to revert a third version of the object to a second version of the object. Similar information may also be maintained for versions 442-443. As a result of the versioning configuration, when a request is received for a particular version, such as the version associated with version 441, the client may apply the undo data for versions 441-443 to obtain the version of the object requested by the process. In applying the versions, the client may first apply version 443, then apply version 442, and finally apply version 441. In this manner, the object may be reverted to each version until the requested version is obtained and provided to the requesting process.

In some implementations, in maintaining the versions, the client may, at various intervals, aggregate versions to improve efficiency in responding to the requests. As a result, rather than requiring the client to apply the undo data for each of the versions, the aggregated version may be used to combine the information in multiple versions to more quickly respond to the request. These aggregated versions may be generated at periodic times, when a defined number of versions have been generated for the object, or at any other similar interval.

Although demonstrated in the example of FIG. 4 as using a table, it should be understood that the versions for a data object may be maintained in one or more tables, linked lists, arrays, or some other data structure, including combinations thereof. In some examples, the versions of the object may be associated with one or more time stamps that can be used in defining a time when the version was active. For example, a process on a client may request a data object that was active at a particular time (data, hour, etc.). In response to the request, the client may identify the version and the corresponding undo data required to supply the data object to the requesting process.

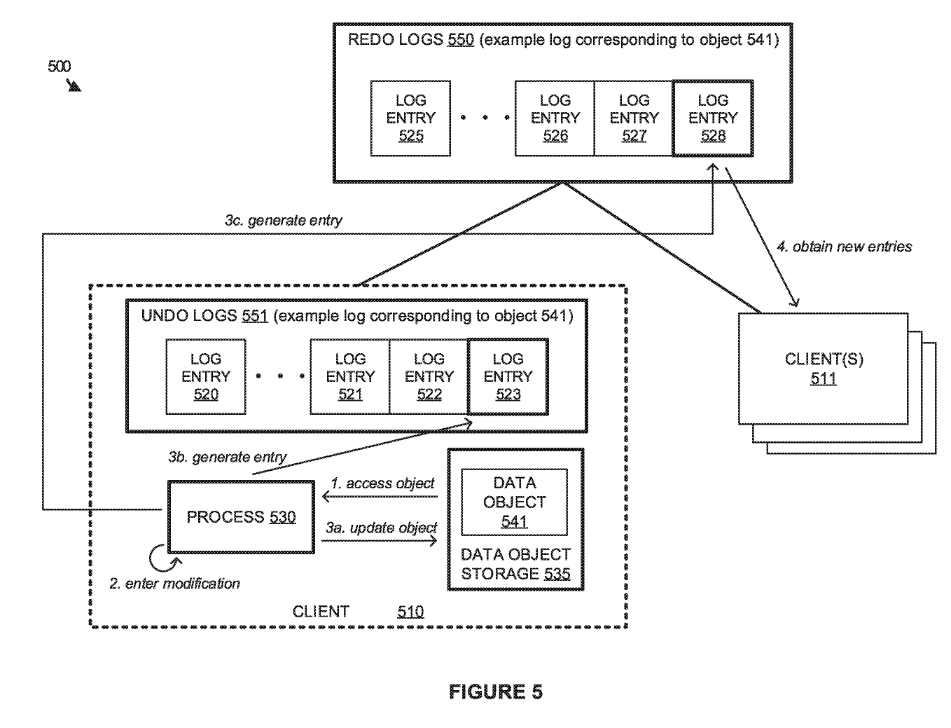

FIG. 5 illustrates an operational scenario 500 of updating redo and undo logs according to an implementation. Operational scenario includes client 510, client(s) 511, and redo logs 550. Client 510 further includes process 530, data object storage 535 with data object 541, and undo logs 551 with log entries 520-523. Redo logs 550 further includes log entries 525-528 corresponding to entries used in updating data object information across multiple clients.

As described herein, computing environments may include multiple clients that share versioned data objects, wherein each of the clients may maintain a copy of the versioned data objects. In operational scenario 500, at step 1, process 530 executing on client 510 requests, and is provided access to, data object 541 in data object storage 535. In providing the data object, client 510 may determine that the request was for the most recent version of the data object and, as a result, provide data object 541 without implementing any undo logs on the data object. Once the data object is provided to process 530, process 530 may enter, at step 2, a modification to the data object. This modification may include a change to a table or some other similar data structure represented by data object 541. Once the modification is entered, sometimes through commit command by a user of client 510, an update operation is performed, at step 3a, to update data object 541 in data object storage 535. As an example, if data object 541 corresponded to a table, and a user of client 510 updated a column in the table, when the user committed the changes to the table, the local copy of data object 541 may be updated to reflect the change.

Additionally, when the modification occurs, client 510, at step 3b, generates log entry 523 in undo logs 551 that corresponds to data object 541. Log entry 523 comprises data that can be used to revert data object 541 to a previous version. As a result, if, at a later instance, a process on client 510 required an older version of data object 541, the data object may be retrieved from data object storage 535, implement required undo log entries to support the earlier version, and provide the data object with the implemented undo log entries to the requesting process. Thus, the undo log entries may provide delta files, wherein when one or more delta files are applied to the particular data object, the data object may be reverted to a version associated with the last undo log entry.

In addition to updating undo logs 551 that correspond to data object 541, operational scenario 500 further generates, at step 3c, an entry into redo logs 550. In particular, redo logs 550 correspond to a shared log that permits other clients within the computing environment to update local versions of the data objects. In the present implementation, when the modification is generated for data object 541, log entry 528 is created within redo logs 550. This entry permits each client in client(s) 511 to obtain, at step 4, the redo log entries and update a local copy of data object 541, as well as add an undo log entry to support reverting the data object to a previous version. In some implementations, client(s) 511 may be configured to obtain data from the redo log at intervals, however, it should be understood that a computing system responsible for the redo log may supply new log entries at periodic intervals, based on a quantity of log entries received, or at any other similar interval.

In some implementations, in updating the redo log, issues may arise of conflicts, wherein a first client may have updated a data object prior to a second client in the computing environment. In such implementations, the redo log may be configured to handle the conflicts in a variety of ways. For example, the redo log may accept updates in the order that they are received and block or prevent entries for later modifications. As a result, if a client in client(s) 511 submitted a log entry prior to log entry 528 from client 510, then log entry 528 may be rejected by the redo log. Additionally, an error message may be provided to client 510 indicating that the modification was not accepted. This notification may cause the data object to be reverted to a state prior to the change from process 530, and may further update undo log entries and data object 541 based on the entry from the client in client(s) 511. In other implementations, different clients may be provided with different forms of priority that permit modifications of one client to overcome changes of a different client. As a result, if client 510 had a higher priority than the other clients, modifications from client 510 may be used supersede the modifications from the other clients in the computing environment.

Although demonstrated in the present example with steps 3a-3c in a particular order, it should be understood that the operations of step 3 may be implemented in any order. For example, it should be understood that client 510 may determine whether any other modifications have been made to the data object by other clients prior to making the modifications locally at client 510. Thus, step 3c may occur prior to steps 3a and 3b in some implementations.

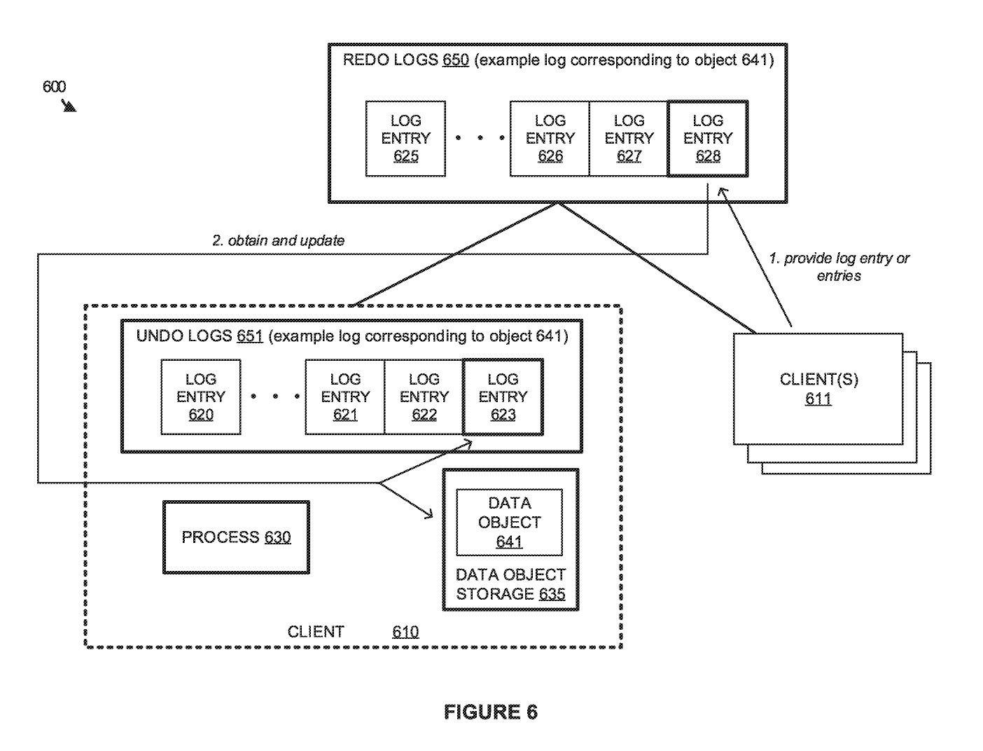

FIG. 6 illustrates an operational scenario of updating locally maintained logs and data objects according to an implementation. Operational scenario includes client 610, client(s) 611, and redo logs 650. Client 610 further includes process 630, data object storage 635 with data object 641, and undo logs 651 with log entries 620-623. Redo logs 650 further includes log entries 625-628 corresponding to entries used in updating data object information across multiple clients.

In operation, computing environments may include multiple clients that share versioned data objects, wherein each of the clients may maintain a copy of the versioned data objects. To support synchronization of the data objects across the multiple clients, redo logs 650 are provided that permits modifications at a first client to be implemented across the other clients in the computing environment. As depicted in the present example, a client in client(s) 611 provides, at step 1, a log entry or entries to redo logs 650. These redo logs are generated as a result of modifications to shared data objects shared between the client systems.

Here, log entry 628 is generated by a client in client(s) 611 and provided to redo logs 650, wherein the log entry corresponds to a redo log entry for data object 641. For example, if a user of the client modified a column of data object 641, then data to implement the modification to the column may be provided as the redo log entry to redo logs 650. Once the redo log entry is supplied to redo logs 650, other clients in the computing environment may obtain the redo log entry to make the required updates. Using the example in operational scenario 600, client 610 obtains log entry 628, and updates data object 641 and undo log 651 to reflect the changes. In updating the undo log, client 610 may identify information that would be required to revert the current version of the data object (created by log entry 628) to the previous version of the data object. Thus, if the modification provided by log entry 628 were to make a change within an entry of a data structure, log entry 623 may reflect the information necessary to revert the entry to its previous state.

Once the update is made within client 610, process 630 may request the most current version of the data object, and may further request any previous version of the data object. For example, if process 630 were to request a version of the data object that were not the current version, then client 610 may apply one or more of log entries 620-623 to provide the process with the required version of the data objection.

Although demonstrated in the present implementation as providing a single log entry from client(s) 611, it should be understood that additional log entries may be supplied for data object 641. Each of the updates may then be supplied to client 610, wherein the entries may be used to update data object 641, and generate log entries within undo log 651. Additionally, while demonstrated as providing log entries for a single data object, it should be understood that entries may be supplied for other data objects in data object storage 635.

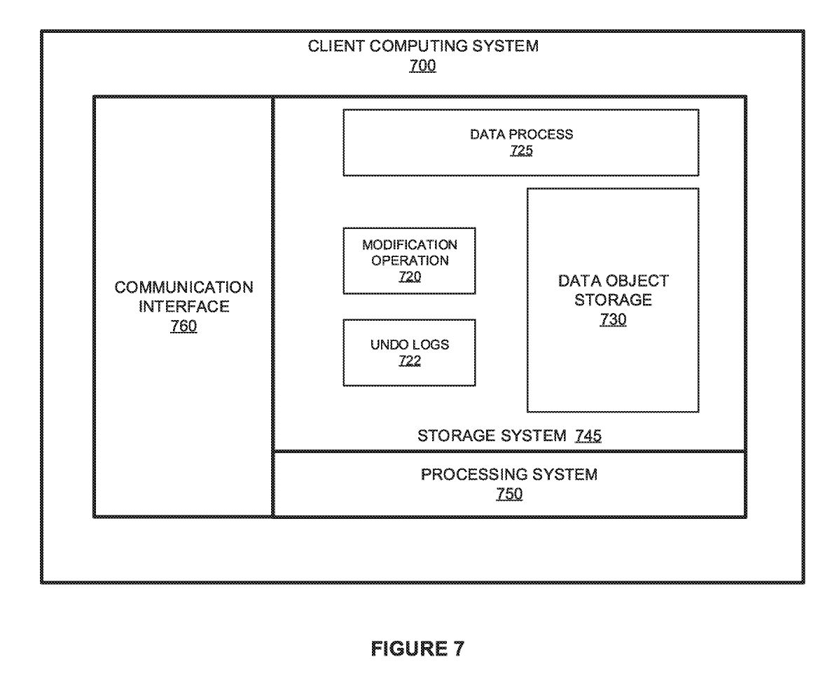

FIG. 7 illustrates a client computing system 700 to manage versioned data objects according to an implementation. Client computing system 700 is representative of any computing system or systems with which the various operational architectures, processes, scenarios, and sequences disclosed herein for a client computing system can be implemented. Client computing system 700 is an example of clients 110-111, although other examples may exist. Client computing system 700 includes storage system 745, processing system 750, and communication interface 760. Processing system 750 is operatively linked to communication interface 760 and storage system 745. Communication interface 760 may be communicatively linked to storage system 745 in some implementations. Client computing system 700 may further include other components such as a battery and enclosure that are not shown for clarity.

Communication interface 760 comprises components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format—including combinations thereof. Communication interface 760 may be configured to communicate with one or more other computing systems that provide support for a data object storage environment. These other computing systems may include other client computing systems, computing systems to store distributed log information, control computing systems, or some other similar computing system.

Processing system 750 comprises microprocessor and other circuitry that retrieves and executes operating software from storage system 745. Storage system 745 may include volatile and nonvolatile, removable and non-removable media implemented in any method or technology for storage of information, such as computer readable instructions, data structures, program modules, or other data. Storage system 745 may be implemented as a single storage device, but may also be implemented across multiple storage devices or sub-systems. Storage system 745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing system 750 is typically mounted on a circuit board that may also hold the storage system. The operating software of storage system 745 comprises computer programs, firmware, or some other form of machine-readable program instructions. The operating software of storage system 745 comprises modification operation 720 with undo logs 722, data process 725, and data object storage 730. The operating software on storage system 745 may further include an operating system, utilities, drivers, network interfaces, applications, or some other type of software. When read and executed by processing system 750 the operating software on storage system 745 directs client computing system 700 to operate as a client described herein in FIG. 1-6.

In at least one implementation, modification operation 720, when read and executed by processing system 750, directs processing system 750 to identify a request for a data object in data object storage 730 by data process 725 also executing on client computing system 700. In response to the request, modification operation 720 may permit data process 725 associated with the request to access the data in the storage system. Once provided, modification operation 720 may identify a modification to the data object and, in response to the modification, update undo logs 722 to reflect the modification and update the data object within data object storage 730. By updating undo logs 722, versions of the data object may be maintained, such that a second process on the same or different client may revisit or reprocesses a previous version of the same data object. In particular, undo logs 722 may maintain the required information to take an object from a new version to a previous version. Additionally, in some examples, redo logs may be updated such that other client computing systems of the computing environment may update their data objects in accordance with the update. The redo logs may be maintained on a separate computing system or may be distributed across the client computing systems of the computing environment in some implementations.

Although demonstrated in the example of FIG. 7 with a single process, it should be understood that multiple processes may execute and access data object storage 730 on client computing system 700. In providing access to the data objects, modification operation 720 may be used to manage conflicts, update the undo and redo logs, and implement any changes to the objects in data object storage 730.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a client system in a plurality of client systems to manage versioned data objects shared by the plurality of client systems, the method comprising:
identifying a request from a process executing on the client system for a data object of the versioned data objects in a first version, wherein each client system of the plurality of client system maintains a copy of the versioned data objects;
providing the process with access to the data object in the first version;
identifying a modification request for the data object from the process to modify the data object from the first version to a second version;
in response to the modification request, generating an undo log entry for an undo log maintained locally by the client system to reflect changes from the first version to the second version; and
updating the data object to the second version.

2. The method of claim 1 further comprising:
generating a redo log entry to reflect changes from the first version to the second version; and
providing the redo log entry to a redo log shared by the plurality of client systems.

3. The method of claim 1 further comprising:
obtaining one or more redo log entries from a redo log shared by the plurality of client systems;
updating the versioned data objects based on the one or more redo log entries.

4. The method of claim 3 further comprising updating the undo log based on the one or more redo log entries.

5. The method of claim 3, wherein obtaining the one or more redo log entries from the redo log comprises obtaining the one or more redo log entries from the redo log at periodic intervals.

6. The method of claim 1 further comprising:
after updating the data object to the second version, obtaining a second request for the data object of the versioned data objects in the first version;
applying the undo log entry to the data object to revert the data object from the second version to the first version; and
providing the process with access to the data object in the first version.

7. The method of claim 1 further comprising:
after updating the data object to the second version, obtaining a second request for the data object of the versioned data objects in a third version;
applying one or more undo log entries to the data object to revert the data object from the second version to the third version; and
providing the process with access to the data object in the third version.

8. The method of claim 1, wherein identifying the modification request for the data object to modify the data object from the first version to the second version comprises identifying a commit action by a user of the client system to modify the data object from the first version to a second version.

9. A computing apparatus:
one or more non-transitory computer readable storage media;
a processing system operatively coupled to the one or more non-transitory computer readable storage media; and
program instructions stored on the one or more non-transitory computer readable storage media to operate a client system in a plurality of client systems to manage versioned data objects shared by the plurality of client systems that, when read and executed by the processing system, direct the processing to at least:
identify a request from a process executing on the client system for a data object of the versioned data objects in a first version, wherein each client system of the plurality of client systems maintains a copy of the versioned data objects;
provide the process with access to the data object in the first version;
identify a modification request for the data object from the process to modify the data object from the first version to a second version;
in response to the modification request, generate an undo log entry for an undo log maintained locally by the client system to reflect changes from the first version to the second version; and
update the data object to the second version.

10. The computing apparatus of claim 9, wherein the program instructions further direct the processing system to:
generate a redo log entry to reflect changes from the first version to the second version; and; and
provide the redo log entry to a redo log shared by the plurality of client systems.

11. The computing apparatus of claim 9, wherein the program instructions further direct the processing system to:
obtain one or more redo log entries from a redo log shared by the plurality of client systems;
update the versioned data objects based on the one or more redo log entries.

12. The computing apparatus of claim 11, wherein the program instructions further direct the processing system to update the undo log based on the one or more redo log entries.

13. The computing apparatus of claim 12, wherein obtaining the one or more redo log entries from the redo log comprises obtaining the one or more redo log entries from the redo log at periodic intervals.

14. The computing apparatus of claim 9, wherein the program instructions further direct the processing system to:
after updating the data object to the second version, obtain a second request for the data object of the versioned data objects in the first version;
apply the undo log entry to the data object to revert the data object from the second version to the first version; and
provide the process with access to the data object in the first version.

15. The computing apparatus of claim 9, wherein the program instructions further direct the processing system to:
after updating the data object to the second version, obtain a second request for the data object of the versioned data objects in a third version;
apply one or more undo log entries to the data object to revert the data object from the second version to the third version; and
provide the process with access to the data object in the third version.

16. The computing apparatus of claim 9, wherein identifying the modification request for the data object to modify the data object from the first version to the second version comprises identifying a commit action by a user of the client system to modify the data object from the first version to a second version.

17. A system comprising:
a plurality of client systems that each maintains a copy of versioned data objects;
a first client system in the plurality of client systems configured to:
identify a request from a process executing on the client system for a data object of the versioned data objects in a first version;
provide the process with access to the data object in the first version;
identify a modification request for the data object from the process to modify the data object from the first version to a second version;
in response to the modification request, generate an undo log entry for an undo log maintained locally by the client system to reflect changes from the first version to the second version; and
update the data object to the second version.

18. The system of claim 17, wherein the first client system is further configured to:
generate a redo log entry to reflect changes from the first version to the second version; and; and
provide the redo log entry to a redo log shared by the plurality of client systems.

19. The system of claim 18, wherein a second client system of the plurality of client systems is further configured to:
obtain one or more redo log entries from the redo log, wherein the one or more redo log entries comprise at least the redo log entry; and
update the versioned data objects of the second client system based on the one or more redo log entries.

20. The system of claim 19, wherein the second client system is further configured to update an undo log of the second client system based on the one or more redo log entries.
